(19) United States
(12) Patent Application Publication
(10) Pub. No.: US 2019/0350807 A1
(43) Pub. Date: Nov. 21, 2019

(54) BAG FOR MEDICAL USE HAVING THREE COMPARTMENTS

(71) Applicant: TECHNOFLEX, Bidart (FR)

(72) Inventors: Isabelle CONSTANT, Briscous (FR); Frédéric BONNET, Bordeaux (FR); Sébastien ETCHEBERRY, Anglet (FR); David GARCIA, Briscous (FR); Daniel ITHURBIDE, Biarritz (FR)

(21) Appl. No.: 16/469,714

(22) PCT Filed: Dec. 15, 2017
(86) PCT No.: PCT/FR2017/053596

§ 371 Date: Jun. 14, 2019

(30) Foreign Application Priority Data
Dec. 16, 2016 (FR) 1662607

(51) Int. Cl. A61J 1/10; A61J 1/20; A61J 1/14

(52) U.S. Cl. CPC A61J 1/10; A61J 1/1475; A61J 1/2093; A61J 1/2034

(57) ABSTRACT

A bag for medical use having three compartments, and having a compartment containing a solvent, a compartment containing a solute and a compartment containing a solvent, the compartment containing a solute being separated from the other two compartments by pincers, the opening of which allows liquid to flow by gravity, and, during opening of one of the pincers and under the effect of a pressure, the liquid contained in one compartment is propelled towards another compartment. A method for using a bag for medical use having three compartments is also provided.

### CROSS REFERENCE TO RELATED APPLICATIONS

This application is a National Stage of International Application No. PCT/FR2017/053596, having an International Filing Date of 15 Dec. 2017, which designated the United States of America, and which International Application was published under PCT Article 21(2) as WO Publication No. 2018/109412 A1, which claims priority from and the benefit of French Patent Application No. 1662607, filed on 16 Dec. 2016, the disclosures of which are incorporated herein by reference in their entireties.

### BACKGROUND

### 1. Field

The present disclosure relates to the field of bags for medical use.

The present disclosure relates more particularly to a bag for medical use having three compartments.

The bag according to the present disclosure is particularly adapted to the field of oncology, and is capable of containing a product for cytotoxic treatment.

### 2. Brief Description of Related Developments

Currently, in the field of oncology, practitioners in a hospital environment use a plurality of bags connected to each other.

This poses difficulties in terms of safety. In particular, the bags of the prior art do not offer securing of the order of administration.

### SUMMARY

The present disclosure intends to overcome the disadvantages of the prior art by proposing a bag for medical use allowing a safe use, both for the patient, and for the medical personnel.

For this purpose, the present disclosure relates, in its broadest sense, to a bag for medical use having three compartments, and having a compartment containing a solvent, a compartment containing a solute and a compartment containing a solvent, the compartment containing a solute being separated from the other two compartments by pincers, the opening of which allows liquid to flow by gravity, wherein, during opening of one of said pincers and under the effect of a pressure, the liquid contained in one compartment is propelled towards another compartment.

Thus, the bag according to the present disclosure allows to secure the preparation of the pharmacist, secure the use by the caregiving personnel and guarantee the taking of the intended dose by the patient.

Preferably, said pincers pinch films forming said bag in order to guarantee the impermeability.

According to one aspect of the present disclosure, said bag further comprises three filling tubes, each of said filling tubes being associated with one of said compartments.

According to one aspect of the present disclosure, said bag further comprises an outlet tube for the administration of the treatment to a patient.

According to one alternative, said pincers are made of plastic material.

Advantageously, after filling of a compartment, a filling tube is definitively closed off.

According to one aspect of the present disclosure, after filling of a compartment, a filling tube is welded and cut in order to close off access to said compartment.

The present disclosure also relates to a method for use of a bag for medical use having three compartments, having the following steps:

Purge of a line by means of a liquid contained in a compartment containing a solvent;

Opening of a pincer separating two compartments, in order to release a solute contained in a compartment; and

Opening of a pincer separating two compartments, in order to release a solvent contained in a compartment.

### BRIEF DESCRIPTION OF THE DRAWINGS

The present disclosure will be better understood via the following description, made below purely for informational purposes, of an aspect of the present disclosure, in reference to the Drawings in which:

FIG. 1 illustrates the bag according to the present disclosure, in one aspect; and

FIG. 2 shows the various steps of the method according to the present disclosure.

### DETAILED DESCRIPTION

The present disclosure relates to a bag 10 for medical use having three compartments 11, 12, 13. This bag 10 comprises a compartment 11 containing a solvent, a compartment 12 containing a solute and a compartment 13 containing a solvent, the compartment 12 containing a solute being separated from the other two compartments 11, 13 by pincers 14, 15, the opening of which allows liquid to flow by gravity.

During opening of one of said pincers 14, 15 and under the effect of a pressure, the liquid contained in a compartment is propelled towards another compartment.

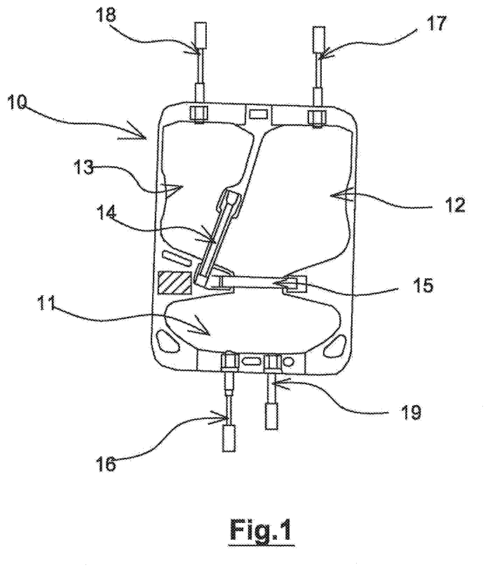

FIG. 1 illustrates the bag according to the present disclosure, in one aspect.

It is observed in FIG. 1 that the bag 10 according to the present disclosure further comprises three filling tubes 16, 17, 18, each of said filling tubes 16, 17, 18 being associated with one of said compartments 11, 12, 13.

After filling of the compartment by the pharmacist, the tube is welded and cut in order to close off access to the compartment, which secures the preparation of the pharmacist.

It is also observed in FIG. 1 that the bag 10 according to the present disclosure further comprises an outlet tube 19 for the administration of the treatment to a patient.

The compartment 11 is used to purge the line. It is impossible to directly use the treatment product, since there would be a risk of contact at the end of the line with the person who implements the present disclosure.

The solute is released after passage of the solvent. An action on a jib crane is carried out.

Moreover, the perfusion line is secured by a peristaltic pump, which detects a presence of air if the intervention of the personnel is too late.

The three compartments 11, 12 and 13 are disposed in such a way as to be able to be administered in the correct order sequentially.

The first compartment 11 contains a solvent, which allows to prime and install the perfusion line without possibility of contact with the product for cytotoxic treatment.

This secures the use by the caregiving personnel.

The third compartment 13 contains a solvent and allows to ensure the administration of the complete treatment dose, which allows to guarantee the taking of the intended dose.

The disposition of the compartments 11, 12 and 13 allows the creation of the bag on opposite-tube automatic-production machines (contrary to the adjacent faces).

The separation of the compartments 11, 12, and 13 is carried out by pincers 14, 15, which are in one aspect made of plastic material. These pincers pinch the two films in order to guarantee the impermeability. This leads to a permanent deformation. Upon the opening of one pincer, a pressure is necessary to propel the liquid towards the following compartment. The propelled liquid improves the rinsing of the compartment.

The present disclosure also relates to a method for use of a bag 10 for medical use having three compartments 11, 12, 13, said method comprising the following steps:

Purge of a line by means of a liquid contained in a compartment 11 containing a solvent;

Opening of a pincer 15 separating two compartments 11, 12, in order to release a solute contained in a compartment 12; and

Opening of a pincer 14 separating two compartments 12, 13, in order to release a solvent contained in a compartment 13.

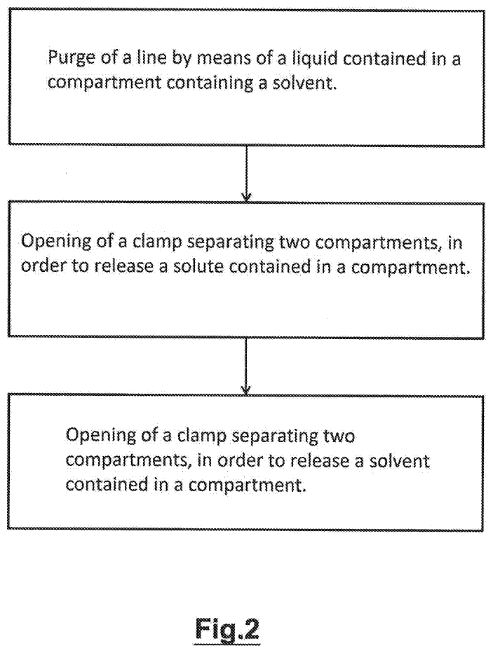

The method according to the present disclosure is illustrated in FIG. 2.

The bag 10 according to the present disclosure is capable of being used in a hospital environment, and also in the home of the patients in the context of home care.

The present disclosure is described above as an example. It is understood that a person skilled in the art is capable of carrying out various alternatives of the present disclosure without actually going beyond the context of the patent.

What is claimed is:

1. A bag for medical use having three compartments, comprising: a compartment containing a solvent, a compartment containing a solute and a compartment containing a solvent, the compartment containing a solute being separated from the other two compartments by pincers, the opening of which allows liquid to flow by gravity, and in that, during opening of one of said pincers and under the effect of a pressure, the liquid contained in one compartment is propelled towards another compartment, and in that after filling of a compartment, a filling tube is welded and cut in order to close off access to said compartment.

2. The bag for medical use having three compartments according to claim 1, wherein that said pincers pinch films forming said bag in order to guarantee the impermeability.

3. The bag for medical use having three compartments according to claim 1, further comprising three filling tubes, each of said filling tubes being associated with one of said compartments.

4. The bag for medical use having three compartments according to claim 1, further comprising an outlet tube for the administration of the treatment to a patient.

5. The bag for medical use having three compartments according to claim 1, wherein said pincers are made of plastic material.

6. The bag for medical use having three compartments according to claim 1, wherein after filling of a compartment, a filling tube is definitively closed off.

7. The bag for medical use having three compartments according to claim 1, wherein the three compartments are disposed in such a way as to be able to be administered in the correct order sequentially.

8. The bag for medical use having three compartments according to claim 1, wherein the first compartment contains a solvent, which allows to prime and install the perfusion line without possibility of contact with a product for cytotoxic treatment.

9. The bag for medical use having three compartments according to claim 1, wherein the third compartment, which contains a solvent, allows to ensure the administration of a complete treatment dose.
